(19) United States
(12) Patent Application Publication
(10) Pub. No.: US 2026/0138224 A1
(43) Pub. Date: May 21, 2026

(54) AUXILIARY MODULE FOR MACHINING EQUIPMENT AND METHOD OF USING THEREOF

(71) Applicant: ASTech Inc., Daejeon (KR)

(72) Inventors: Hwan Ho MAENG, Daejeon (KR); Min-Gab BOG, Daejeon (KR); Gun Hee KIM, Sejong (KR)

(21) Appl. No.: 19/446,756

(22) Filed: Jan. 12, 2026

Related U.S. Application Data
(63) Continuation of application No. PCT/KR2024/010069, filed on Jul. 12, 2024.

(30) Foreign Application Priority Data
Jul. 13, 2023 (KR) 10-2023-0090973

(51) Int. Cl. B23Q 11/10

(52) U.S. Cl. CPC B23Q 11/10

(57) ABSTRACT

The present invention relates to an auxiliary module for machining equipment, specifically for assisting physical machining tools used in metal processing. The module is configured to irradiate a laser beam through a through-hole where water or cutting fluid is sprayed. This configuration achieves a focusing effect of the light beam via the liquid column while alleviating surface hardness of the workpiece, facilitating smoother machining by the physical tool. To achieve technical objects, the module comprises a light source supply unit for supplying the light beam and a liquid supply unit for providing the liquid. The liquid supply unit includes a nozzle unit configured to spray the liquid synchronously with the light beam supplied from the light source supply unit. Both the light beam and the liquid reach the machining position or a position ahead of the tool's path. This allows for precise surface softening and significantly enhanced tool performance.

### CROSS-REFERENCE TO RELATED APPLICATIONS

The present application is a continuation of International Application No. PCT/KR2024/010069, filed on July 12, 2024, which claims priority to Korea Patent Application No. 10-2023-0090973, filed with the Korean Intellectual Property Office on July 13, 2023. The entire contents of the applications are incorporated herein by reference in their entireties.

### TECHNICAL FIELD

The present invention relates to an auxiliary module for machining equipment. More particularly, the present invention relates to an auxiliary module for assisting the machining process of a physical tool generally used in a machining apparatus for processing metal. The auxiliary module is configured to irradiate a laser beam into a through-hole where water or cutting fluid is sprayed in the form of a liquid column during the use of a physical tool. This allows the laser light beam to be focused and guided through the sprayed water or cutting fluid, thereby softening the surface of a workpiece and mitigating physical properties thereof, which enables smooth machining via the physical tool.

### BACKGROUND OF THE INVENTION

As technology advances, mechanical devices have also evolved, and such mechanical devices are required to have high durability and precise shapes. To manufacture these mechanical devices, it is necessary to maintain machining precision for the components constituting the mechanical devices, and the materials for the components also need to be manufactured using materials with high durability.

However, to ensure the durability of components, it is common to use difficult-to-machine materials, such as materials with high strength, brittle materials prone to breaking, or highly ductile materials that tend to stick to tools. To process the shapes of components using such materials, there is a demand for a machining apparatus capable of high-precision machining on difficult-to-cut materials.

Briefly looking at conventional commercialized machining apparatuses for such components, there has been a method of applying ultrasonic vibration to a physical tool for machining to improve cutting force. Although this improves machinability and precision for high-strength materials, it suffers from very long machining times. Furthermore, since it relies on improving the cutting force of the tool through ultrasonic vibration, it requires machining adjustments considering the tool gap according to vibration, leading to high difficulty in use.

Another method is a magnetorheological fluid polishing method, which utilizes a fluid that reacts to magnetic force. It operates by applying magnetic force so that a shear plane is formed on the surface to be machined. However, this method makes machining difficult if the material itself is magnetic and is limitedly used mainly for surface polishing of non-magnetic objects such as lenses.

Therefore, in machining and polishing components or products using high-strength materials, there is an urgent need for the development of a machining means or technology that can provide high precision and rapid machinability without being affected by the properties of the workpiece.

### DETAILED DESCRIPTION OF THE INVENTION

### Technical Challenges

Accordingly, the present invention has been made to solve the above-mentioned conventional problems, and an object thereof is to provide an auxiliary module for machining equipment capable of improving machining precision for high-strength materials regardless of the type of material.

Another object of the present invention is to provide an auxiliary module for machining equipment that can improve machining speed along with machining precision.

Still another object of the present invention is to provide an auxiliary module for machining equipment configured to be installable in an add-on type on conventional machining apparatuses, thereby improving the accessibility of the device.

Yet another object of the present invention is to provide an auxiliary module for machining equipment that improves machinability while maintaining a usage method not significantly different from that of conventional devices, thereby preventing a significant increase in the difficulty or complexity required to utilize the device.

### Technical Solution

To achieve the above technical objects, an auxiliary module for machining equipment according to an embodiment of the present invention is an auxiliary module for assisting the machining of a surface of a material by a machining tool, comprising: a light source supply unit for supplying a light beam to be irradiated onto the surface of the material; and a liquid supply unit for supplying a liquid including water or cutting fluid, wherein the liquid supply unit includes a nozzle unit configured to spray the liquid together with the light beam supplied from the light source supply unit, and the light beam and the liquid are configured to reach a machining position of the machining tool or a position ahead of a machining path.

In the auxiliary module for machining equipment according to an embodiment of the present invention, the light source supply unit may comprise: a light source generating device for generating a light beam; and one or more light source lenses provided to focus or converge the light source generated by the light source generating device.

In the auxiliary module for machining equipment according to an embodiment of the present invention, the light source irradiated through the light source supply unit is a laser light source, and may be configured with a structure where the output is provided or adjusted to a level capable of inducing a softening effect on the surface of the material to be machined.

In the auxiliary module for machining equipment according to an embodiment of the present invention, the nozzle unit may be configured with a structure that sprays the liquid so as to reach the surface of the material in the form of a liquid column.

In the auxiliary module for machining equipment according to an embodiment of the present invention, the light source supply unit may comprise: a light source part provided to supply the light beam; and a boundary part forming an interface in contact with the liquid of the liquid supply unit in front of the light source part, wherein the light source part is configured in a structure that is repositionable relative to the nozzle unit.

Further, a machining method according to an embodiment of the present invention is a machining method for performing machining on a surface of a material by a machining tool, comprising the steps of: preparing an auxiliary module for machining equipment, capable of spraying a liquid including water or cutting fluid, in the vicinity of the machining tool; fixing the material to be machined to a bed or a spindle; and machining the material by bringing the machining tool close to the surface of the material, wherein the step of machining the material comprises spraying the liquid from the auxiliary module for machining equipment to a machining position of the machining tool or ahead of a machining path, while the light beam of the auxiliary module for machining equipment is configured to be irradiated through the liquid.

### Effects of the Invention

According to the technical solutions described above, the auxiliary module for machining equipment according to the present invention has the effect of improving machining precision for materials with high strength or brittleness, regardless of the material type. In addition, it has the effect of improving machining speed along with machining precision.

Furthermore, in configuring a machining apparatus, it is configured to be installable in an add-on type on conventional machining equipment, thereby improving the accessibility of the device. In addition, it improves machinability while the usage method is not significantly different from conventional devices, thereby improving usability by not significantly increasing the difficulty or complexity required to utilize the device.

The effects of the present invention are not limited to the above-mentioned effects, and should be understood to include all effects that can be inferred from the configuration of the invention described in the detailed description or the claims.

### BRIEF DESCRIPTION OF THE DRAWINGS

FIG. 1 is a conceptual diagram illustrating a machining process for machining a material using an auxiliary module for machining equipment or a machining method according to an embodiment of the present invention.

FIG. 2 is a perspective view showing the appearance of an auxiliary module for machining equipment according to an embodiment of the present invention.

FIG. 3 is a 3/4 sectional perspective view illustrating the detailed structure of an auxiliary module for machining equipment according to an embodiment of the present invention.

FIG. 4 is an exploded perspective view illustrating the detailed configuration of an auxiliary module for machining equipment according to an embodiment of the present invention.

FIGS. 5A to 5C are explanatory views illustrating a modified embodiment of a spacer of an auxiliary module for machining equipment according to an embodiment of the present invention.

FIG. 5A is a view illustrating a state before mutual coupling in an embodiment where a length-adjustable spacer of a light source part is configured by being divided into an outer diameter spacer and an inner diameter spacer.

FIG. 5B is a view illustrating a process of adjusting a length by coupling the outer diameter spacer and the inner diameter spacer shown in FIG. 5A.

FIG. 5C is a view illustrating a state including a fixing ring for limiting additional length changes in the length-adjustable spacer.

FIG. 6 is a front view illustrating the structure of an auxiliary module for machining equipment according to an embodiment of the present invention.

FIG. 7 is a cross-sectional view illustrating the structure of an auxiliary module for machining equipment according to an embodiment of the present invention.

FIG. 8 is a cross-sectional view illustrating a state before coupling a light source supply unit and a liquid supply unit of an auxiliary module for machining equipment according to an embodiment of the present invention.

FIG. 9A and 9B are cross-sectional views illustrating modified embodiments of a liquid supply unit of an auxiliary module for machining equipment according to an embodiment of the present invention.

FIG. 9A is a cross-sectional view illustrating a modified embodiment of the liquid supply unit provided with a pressure-reducing valve that operates according to internal pressure and has an elastically supported sealing structure.

FIG. 9B is a cross-sectional view illustrating a modified embodiment of the liquid supply unit provided with a pressure-reducing valve controlled according to an internal pressure sensed by an internal pressure sensor.

FIG. 10A is a cross-sectional view illustrating an embodiment in which a nozzle unit is detachably assembled to a front end of a liquid supply unit in an auxiliary module for machining equipment according to an embodiment of the present invention.

FIG. 10B is a cross-sectional view illustrating embodiments for changing a flow path diameter or a length of the nozzle unit shown in FIG. 10A.

FIG. 10C is a cross-sectional view illustrating an embodiment in which the nozzle unit is replaced and assembled by changing a flow path diameter and a length relative to the nozzle unit shown in FIG. 10A.

FIG. 11 is a cross-sectional view showing a coupling structure of a light source part and a boundary part of a light source supply unit of an auxiliary module for machining equipment according to an embodiment of the present invention.

FIG. 12 is a cross-sectional view showing a structure in which the coupling position is adjustable in the coupling structure of the light source part and the boundary part of the light source supply unit of the auxiliary module for machining equipment according to an embodiment of the present invention.

FIG. 13 is a conceptual diagram illustrating drilling machining as another example of a machining process using an auxiliary module for machining equipment or a machining method according to an embodiment of the present invention.

### Best Modes for Carrying Out the Invention

Hereinafter, the present invention will be described with reference to the accompanying drawings. However, the present invention may be implemented in various different forms and, therefore, is not limited to the embodiments described herein.

Throughout the specification, when a part is said to be "connected (joined, contacted, or coupled)" to another part, this includes not only cases of "direct connection" but also cases of "indirect connection" with another member interposed therebetween. In addition, when a part "includes" or "comprises" a certain component, it means that it may further include other components rather than excluding other components, unless specifically stated otherwise.

The terms used in this specification are only used to describe specific embodiments and are not intended to limit the present invention. Singular expressions include plural expressions unless the context clearly indicates otherwise. In this specification, terms such as "comprise" or "have" are intended to designate the existence of features, numbers, steps, operations, components, parts, or combinations thereof described in the specification, and it should be understood that they do not preclude the possibility of the presence or addition of one or more other features, numbers, steps, operations, components, parts, or combinations thereof.

Hereinafter, preferred embodiments of the present invention will be described in detail with reference to the accompanying drawings so that those of ordinary skill in the art can easily implement the present invention.

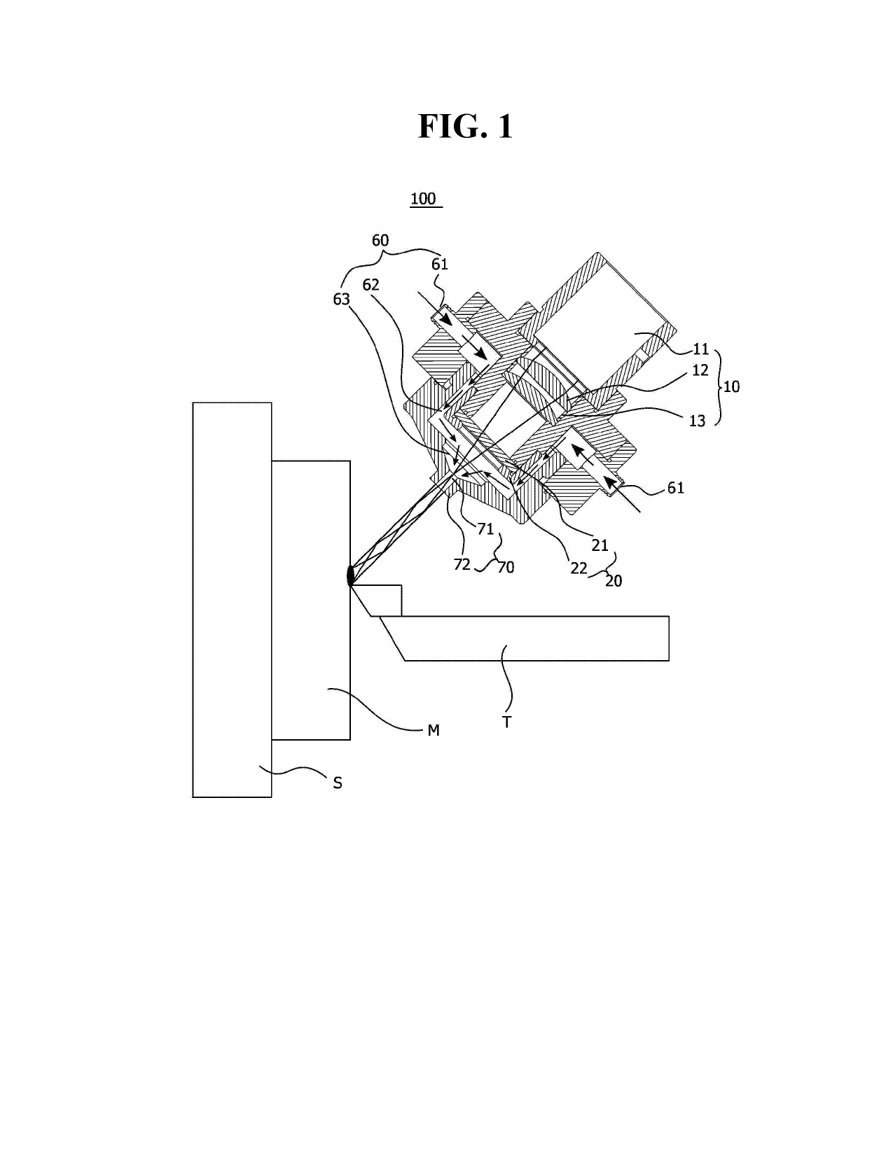

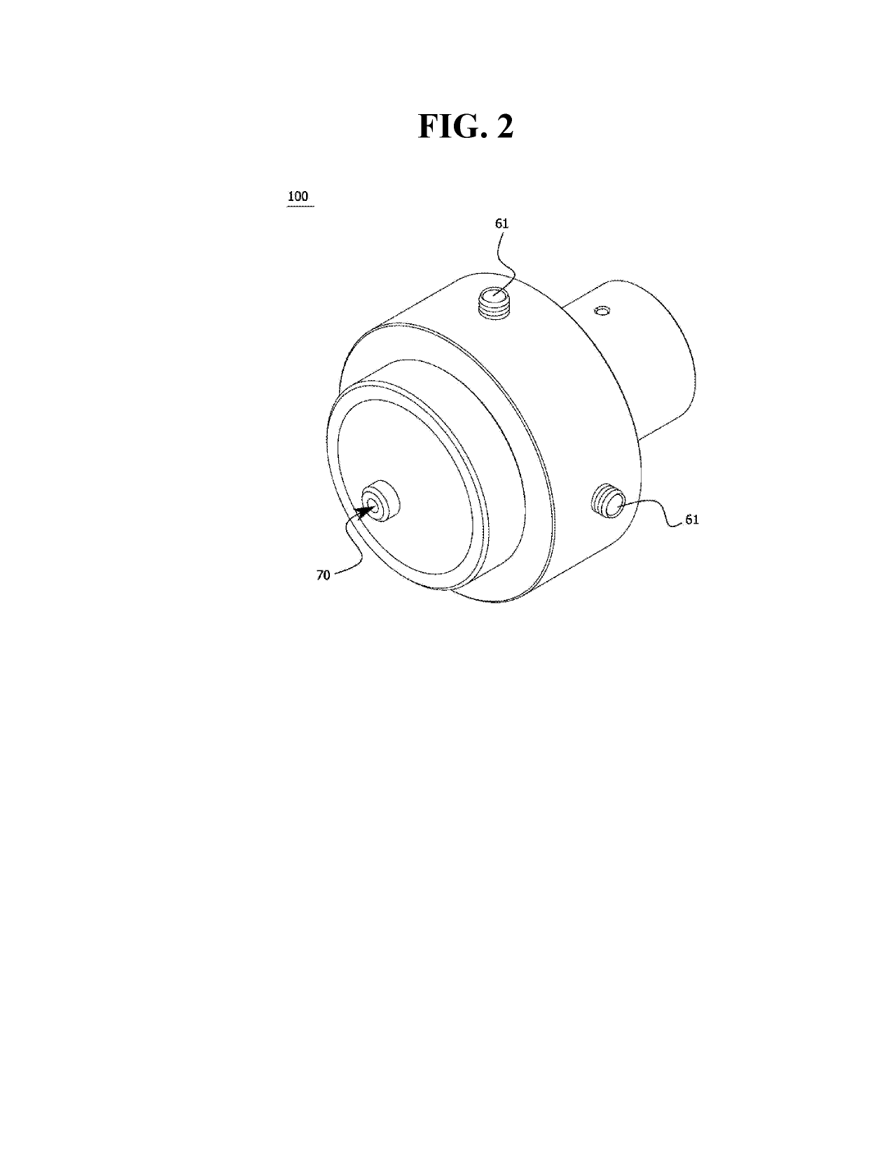

First, referring to each drawing, FIG. 1 is a conceptual diagram for explaining a method of machining a material (workpiece) using an auxiliary module for machining equipment according to an embodiment of the present invention, and is a view shown to explain and facilitate understanding of a machining method for a part or product composed of a high-strength material using the apparatus. FIG. 2 is a perspective view showing the appearance of an auxiliary module for machining equipment according to an embodiment of the present invention, and is a view shown to explain and facilitate understanding of the appearance of the apparatus.

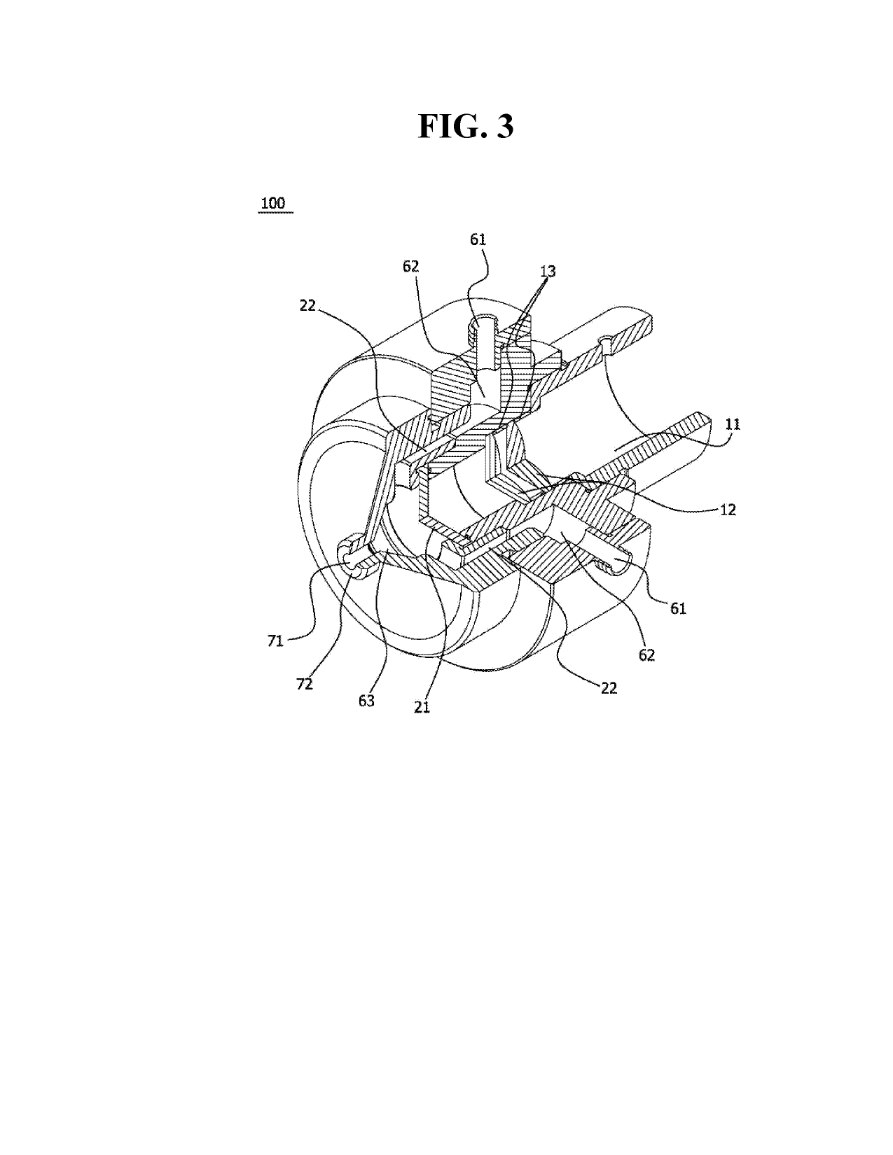

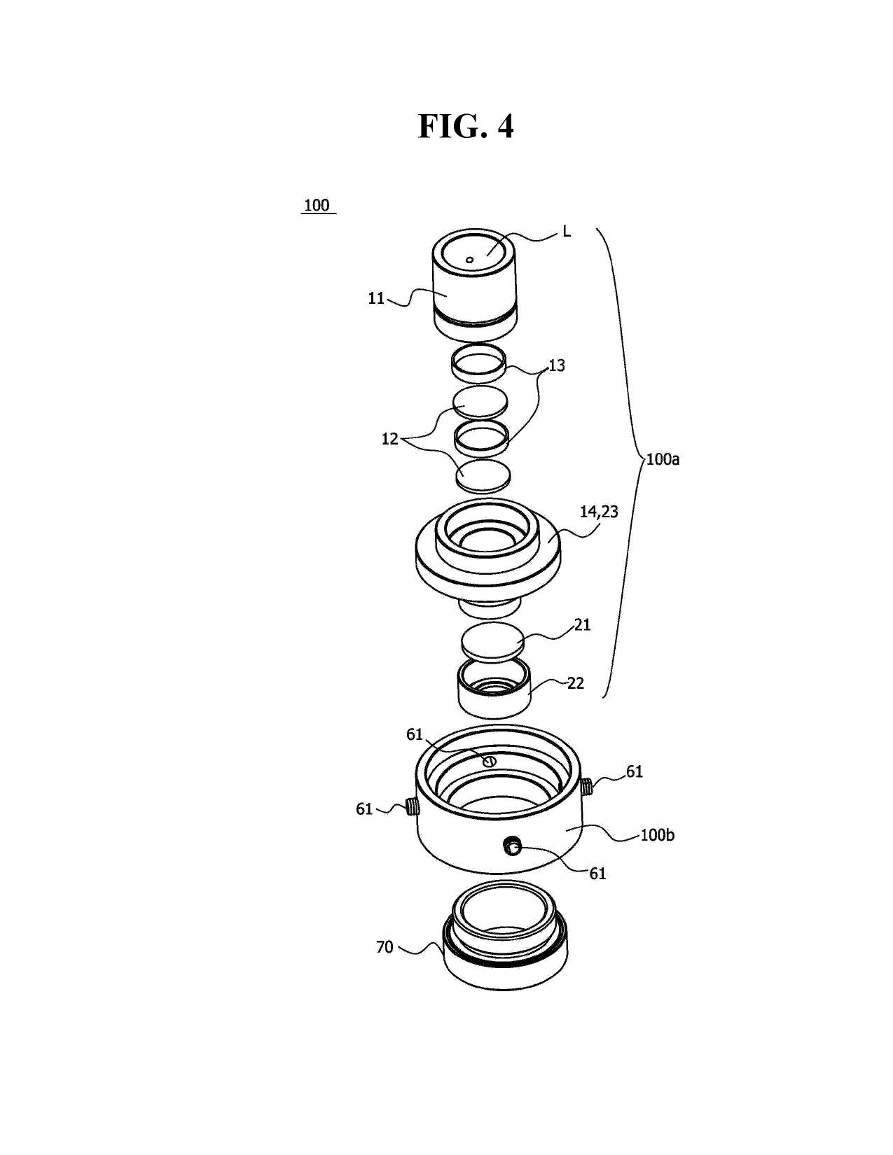

FIG. 3 is a 3/4 sectional perspective view illustrating the detailed structure of an auxiliary module for machining equipment according to an embodiment of the present invention, showing the internal structure and coupling relationship of the light source supply unit and the liquid supply unit. FIG. 4 is an exploded perspective view illustrating the detailed configuration of an auxiliary module for machining equipment according to an embodiment of the present invention, exemplarily showing the shape and coupling relationship of each component.

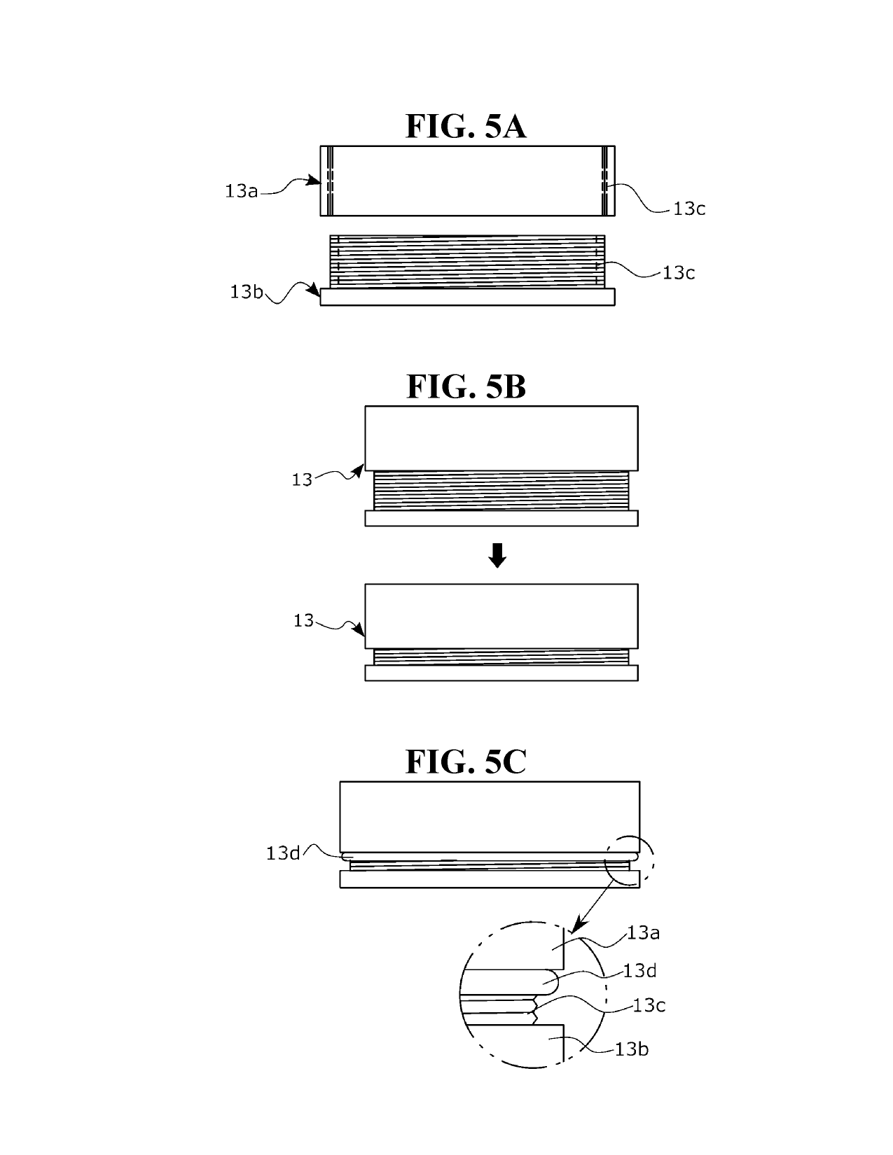

FIG. 5A to 5C are an explanatory diagram illustrating a modified embodiment of a spacer of an auxiliary module for machining equipment according to an embodiment of the present invention, showing structural features of a form in which the length of the spacer is adjustable.

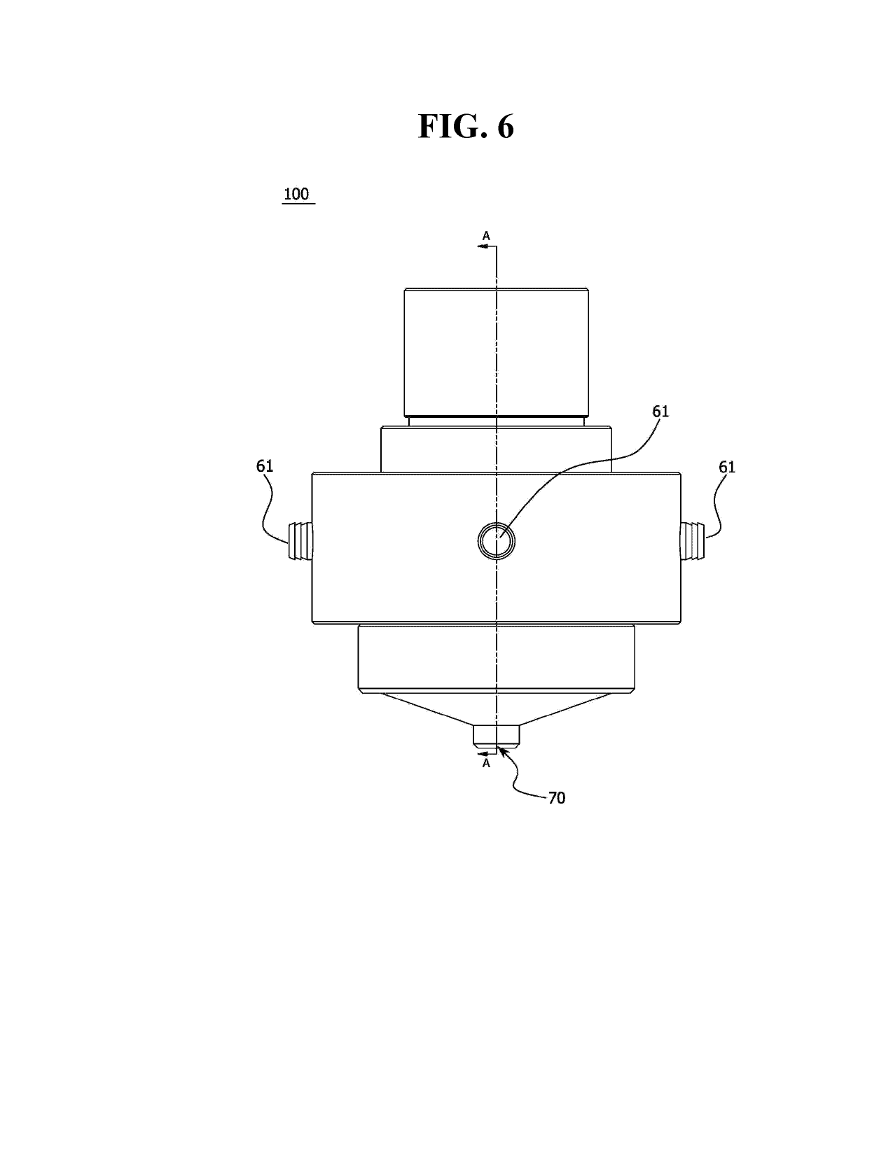

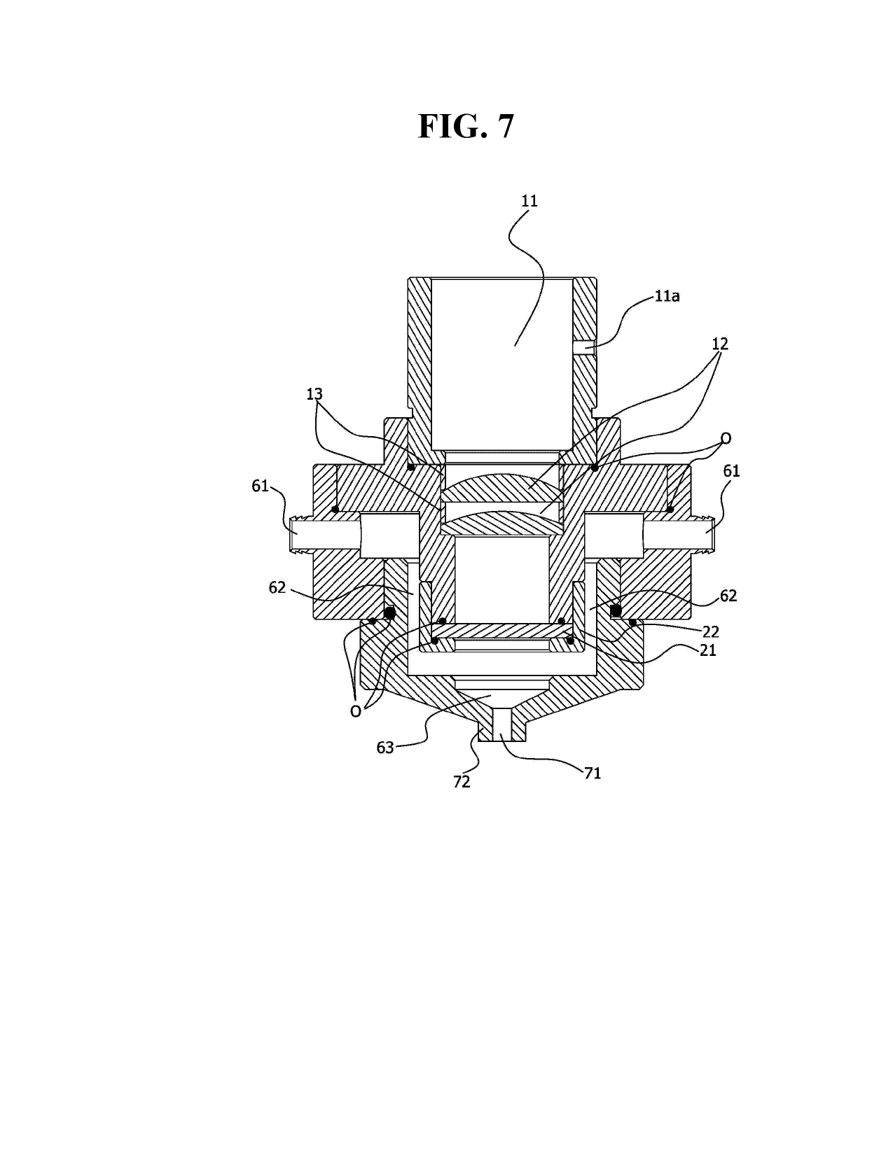

FIG. 6 is a front view illustrating the structure of an auxiliary module for machining equipment according to an embodiment of the present invention, explaining the external standards of the device prior to the description of the internal structure. FIG. 7 is a cross-sectional view illustrating the structure of an auxiliary module for machining equipment according to an embodiment of the present invention, explaining the internal structures of the light source supply unit, the liquid supply unit, and the nozzle unit.

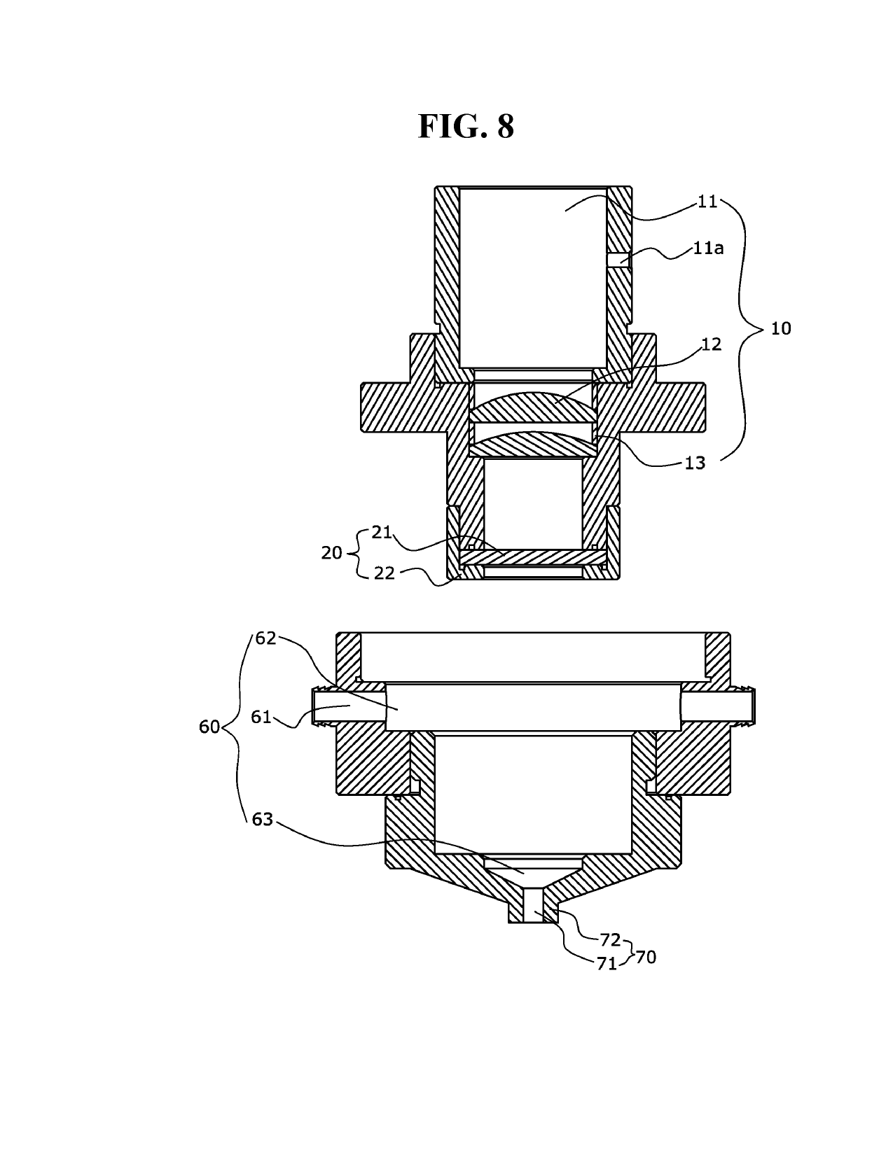

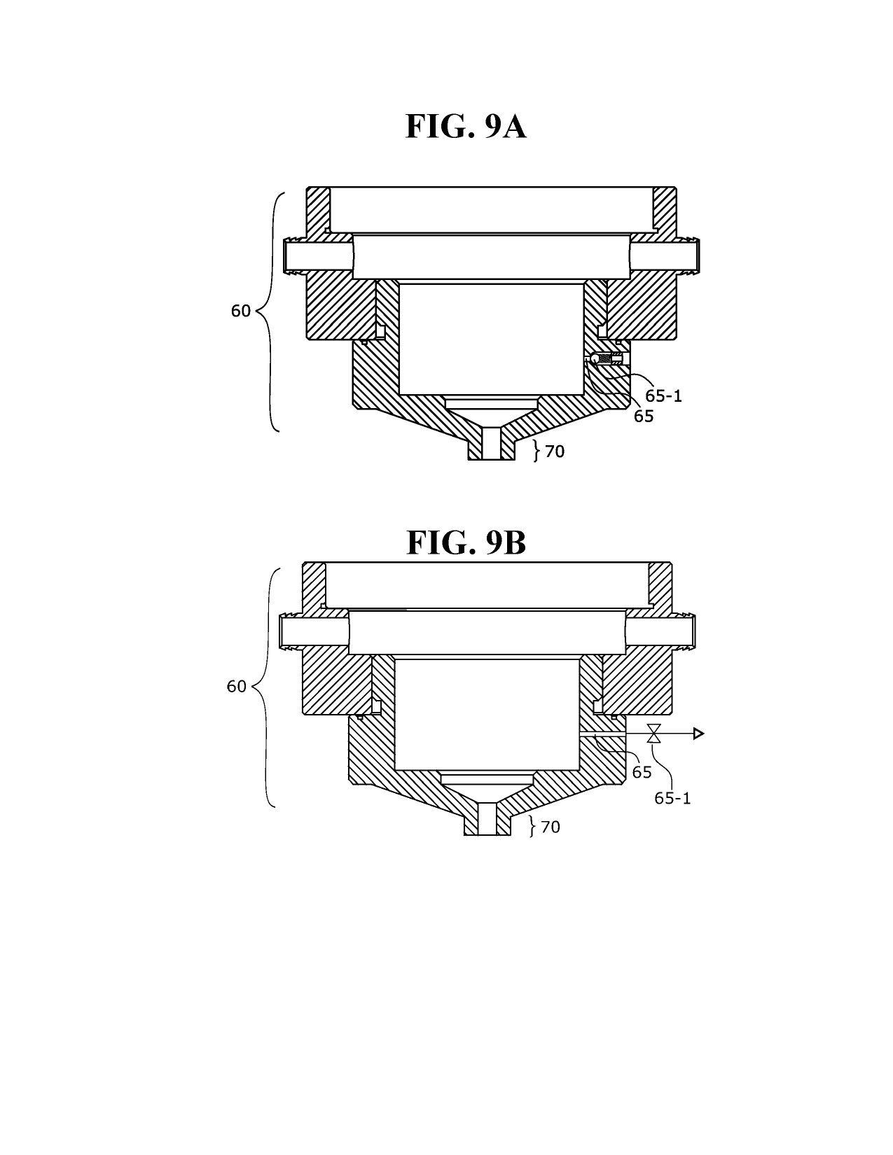

FIG. 8 is a cross-sectional view illustrating a state before coupling a light source supply unit and a liquid supply unit of an auxiliary module for machining equipment according to an embodiment of the present invention, explaining the configuration in which a supply flow path is formed through the coupling of the light source supply unit and the liquid supply unit. FIG. 9A to 9B are a cross-sectional view showing a modified embodiment of a liquid supply unit in an auxiliary module for machining equipment according to an embodiment of the present invention, explaining a configuration provided with an outlet for discharging a part of the liquid flow rate or partially reducing the flow pressure on one side of the liquid supply unit.

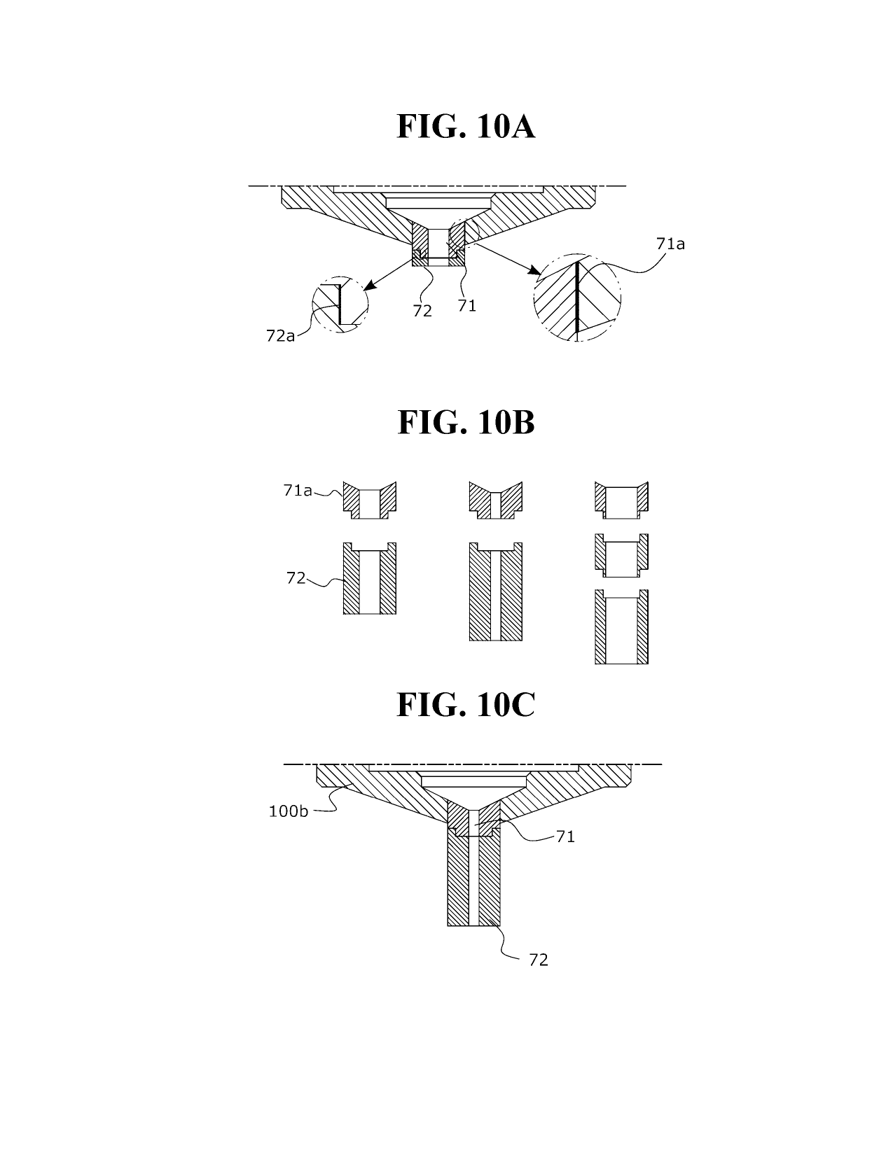

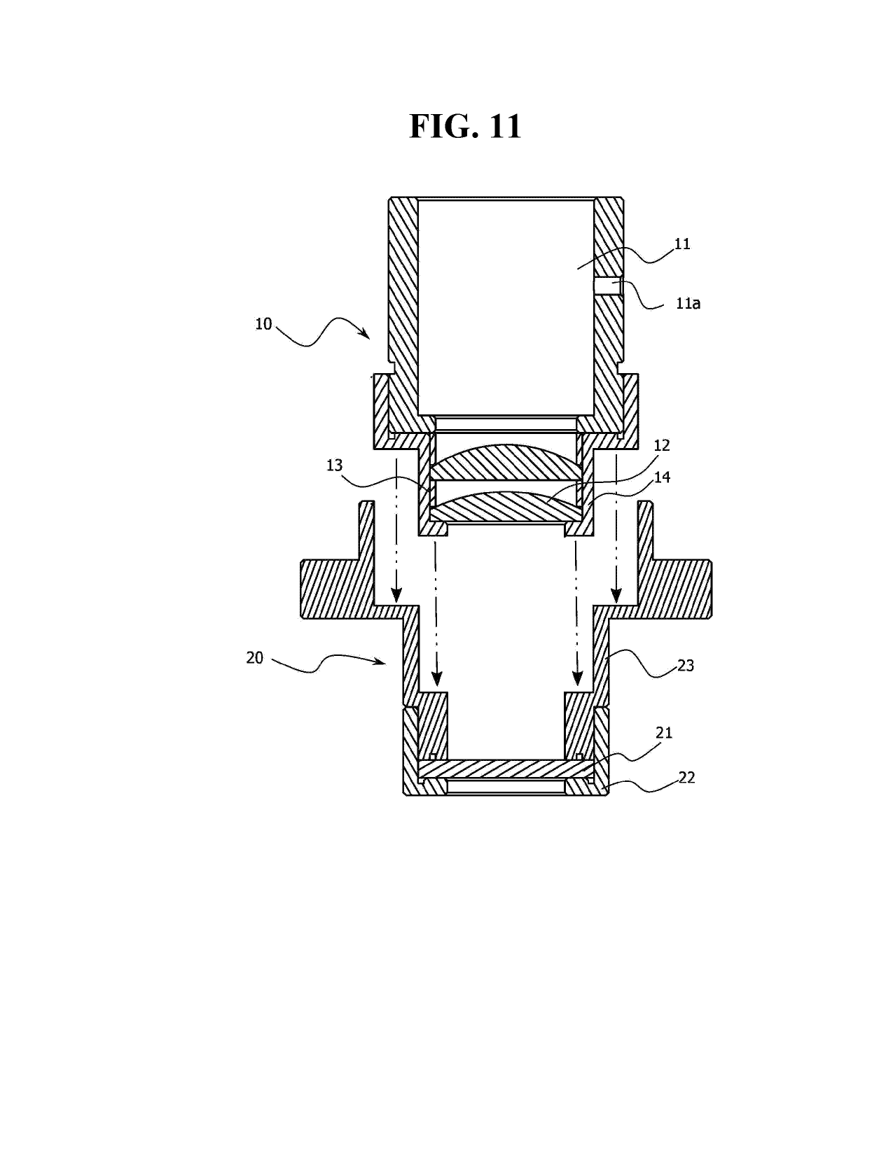

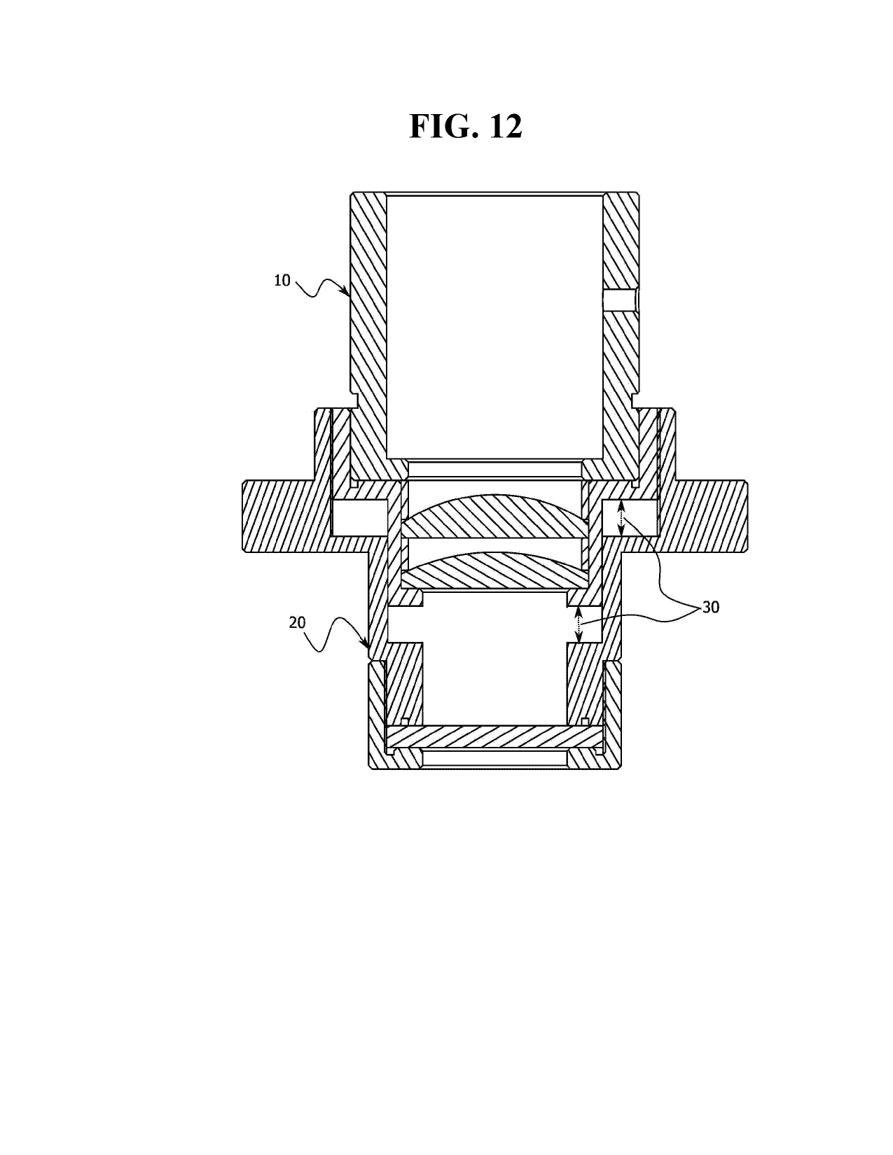

FIG. 10A to 10C are a cross-sectional view showing a spray port of a liquid supply unit of an auxiliary module for machining equipment according to an embodiment of the present invention, explaining a structure in which the diameter and nozzle length are replaceable through a replaceable structure of the spray port. FIG. 11 is a cross-sectional view showing a coupling structure of a light source part and a boundary part of a light source supply unit of an auxiliary module for machining equipment according to another embodiment of the present invention, explaining a form in which the light source part and the boundary part can be separated so that only the light source part can be easily replaced. FIG. 12 is a cross-sectional view showing a structure in which the coupling position is adjustable in the coupling structure of the light source part and the boundary part of the light source supply unit of the auxiliary module for machining equipment according to an embodiment of the present invention, explaining a structure for easily adjusting the focus or concentration of the light beam on the machining surface by forming a structure for changing the position of the light source part or the boundary part relative to the nozzle unit.

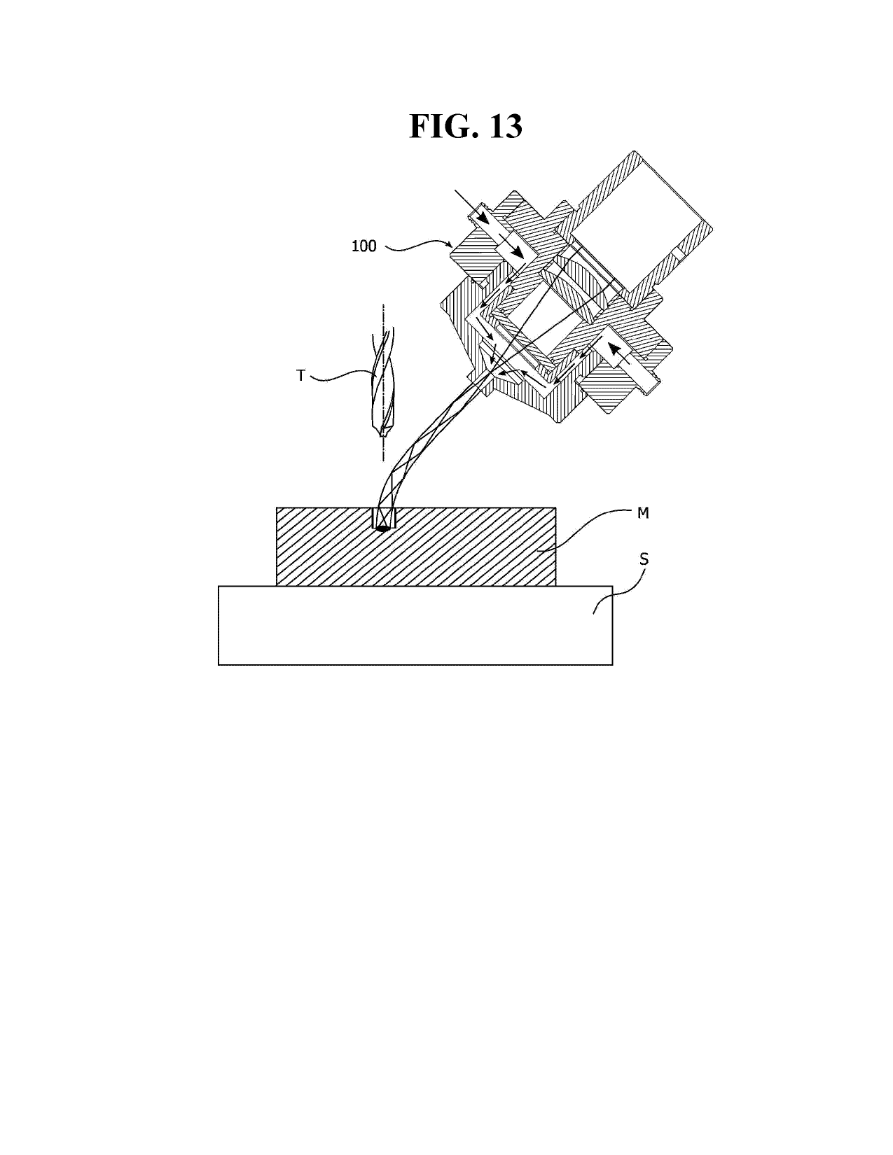

FIG. 13 is a conceptual diagram illustrating drilling machining as another example of a machining process using an auxiliary module for machining equipment or a machining method according to an embodiment of the present invention, explaining a machining process in which the machining position—such as the surface of the workpiece or the bottom of a hole being processed—is softened through liquid spraying and light beam irradiation in a stage prior to the approach of the machining tool, followed by the approach of a drilling tool for machining.

As shown in FIGS. 1 to 13, the auxiliary module for machining equipment or the machining method of the present invention is an apparatus or method for precise machining of a rigid material and can be used for machining parts or products requiring high strength and high precision.

Various methods are used to produce components or products of mechanical devices. In consideration of the strength and shape of the components, a method of machining a hard material into a desired external or local shape through mechanical machining such as cutting, drilling, and milling is widely used. Such mechanical machining involves refining the appearance or local areas by at least partially paring, cutting, or grinding the material. The machining apparatus may be configured such that a tool for machining the material is harder than the material or is configured to apply a large external force, facilitating the tool's machining of the material surface.

Therefore, depending on the material of the product or mechanical component to be machined, the material of the tool also needs to be composed of a high-strength material. Accordingly, among the materials of tools currently used for machining products or components, the most widely used are machining tools using industrial diamonds or high-strength metal materials.

However, as the required strength of products or components has recently increased, the use of tools formed of materials such as industrial diamonds has reached a limit in tool strength. Consequently, tool wear progresses simultaneously with the machining of products or components, causing the shape of the tool to be damaged as machining progresses, which leads to difficulties in machining sophisticated shapes of products or components.

Therefore, as shown in FIG. 1, the auxiliary module for machining equipment of the present invention aims to provide an auxiliary module or device for machining capable of improving machining precision without being affected by the material of the workpiece (M).

The auxiliary module for machining equipment may be configured to be additionally installed on conventional machining equipment. It may be formed separately and installed near the machining equipment to assist the machining process, or it may be included as a component of the machining equipment. Through this, it can be configured to supply a liquid such as water or cutting fluid to a contact point of a tool (T) that comes into contact for machining a workpiece (M) fixed to a conventional bed or spindle (S), and simultaneously irradiate a laser light beam.

Accordingly, as the laser is irradiated to the machining position of the tool or ahead of the machining path, the strength or brittleness of the surface of the workpiece can be lowered. In this state, when the tool contacts and performs mechanical machining on the surface of the workpiece, the machining of the workpiece can proceed easily, and the wear rate of the tool can be reduced.

Meanwhile, as shown in FIGS. 2 to 4, the auxiliary module for machining equipment according to an embodiment of the present invention may comprise a light source supply unit (100a) and a liquid supply unit (100b).

First, in the auxiliary module for machining equipment according to an embodiment of the present invention, the light source supply unit (100a) may be configured to include a light source part (10) and a boundary part (20) in order to supply a laser light beam for the operation of the auxiliary module and to perform roles such as adjusting the focus or concentration of the laser light beam according to the environment during the machining operation.

At this time, the light source part (10) of the light source supply unit (100a) may comprise a light source mount (11), a light source lens (12), and a spacer (13).

The light source part (10) of the light source supply unit (100a) may be configured in a form where the center is hollowed out (through-hole), and the light source mount (11) may be provided at the rear end thereof. A light beam generating device (L) for generating a laser light beam is mounted on the light source mount (11), and a grub bolt or a fastening bolt may be coupled to a mounting/fixing hole (11a) to fix the device.

The light beam generating device (L) may be selected and used from commercial products. In an embodiment of the present invention, the device is configured by applying a device capable of outputting a laser beam of up to 100W, but it should be noted that the output of the light beam generating device (L) is not limited thereto.

Since the laser light generated from the light beam generating device (L) is configured to be irradiated through the through-hole formed in the center of the light source supply unit (100a), it is preferable that one or more light source lenses (12) for adjusting the light path of the light beam are disposed at the front end of the light source mount (11) where the light beam generating device (L) is mounted.

The light source lens (12) may be configured to transmit and simultaneously refract and focus the light beam generated and provided from the light beam generating device (L), acting as a device for adjusting the focus of the light beam so that it can be irradiated onto the surface of the workpiece, which is the machining target of the present invention.

In addition, when the light source lens (12) focuses while transmitting the light beam generated from the light beam generating device (L), it is necessary to maintain a constant distance between the light beam generating device (L) and the light source lens (12). As a device for maintaining this distance, a spacer (13) may be additionally provided.

Here, it is preferable to configure the distance between the light beam generating device (L) and the light source lens (12) to be easily adjustable according to the length of the spacer (13). For this purpose, a plurality of spacers (13) having different lengths may be provided for replacement, or the spacer (13) itself may be formed in a structure whose length is adjustable to regulate the distance between the light beam generating device (L) and the light source lens (12).

Such a structure of the length-adjustable spacer (13) may be configured, for example, as shown in FIG. 5A to 5C, to be divided into an outer diameter spacer (13a) and an inner diameter spacer (13b). Threads (13c) are formed on the inner diameter of the outer diameter spacer (13a) and the outer diameter of the inner diameter spacer (13b), respectively, so that the length can be adjusted in a screw-coupled form through the threads (13c).

The threads (13c) may be configured as a full-thread type in which threads are formed on the entire inner diameter of the outer diameter spacer (13a) and the entire outer diameter of the inner diameter spacer (13b) inserted into the inner diameter of the outer diameter spacer (13a), so that the displacement for length adjustment of the spacer (13) is maximized.

In addition, as a configuration for limiting the change in length while the length of the spacer (13) is adjusted, a fixing ring (13d) is provided on the outside of the inner diameter spacer (13b), whereby the length adjustment of the spacer (13) can be limited through the fixing ring (13d).

The fixing ring (13d) may be formed of rubber or a structure having elasticity. By being positioned at a screw-coupling point between the outer diameter spacer (13a) and the inner diameter spacer (13b) and acting to dig between the threads (13c), it can restrict the inner diameter spacer (13b) from further digging into the inside of the outer diameter spacer (13a), thereby having an effect of preventing a change in the length of the spacer (13).

Therefore, when it is necessary to change the position or the number of the light source lenses (12) inside the light source part (10), the light source lenses (12) can be firmly fixed by changing the length of the spacer (13), and the focusing state or focal point of the light beam supplied from the light beam generating device (L) can be adjusted through the change of such a coupling relationship.

In the drawings related to the above embodiment, a form in which two light source lenses are provided is expressed as an example, and accordingly, a form in which the spacer (13) is disposed between the light source lenses (12) is also expressed. However, the form in which two light source lenses are provided is presented as an embodiment of the present invention, and it should be noted that the present invention is not limited thereto. The light source lens (12) and the spacer (13) may be configured by adjusting the number, position, etc., as necessary.

Meanwhile, in the auxiliary module for machining equipment according to an embodiment of the present invention, the boundary part (20) constituting the light source supply unit (100a) is located at the front end of the light source supply unit (100a) and may comprise a boundary window (21) and a window holder (22) as its detailed configuration.

The boundary window (21) is a window structure for transmitting the light beam focused in the light source part (10) and may be composed of a transparent material capable of passing the light beam. It is formed at a position in contact with a liquid collection part (63) of the liquid supply unit (100b), which will be described in detail later, and can function as a member for forming a boundary surface with the liquid supplied from the outside.

Therefore, to efficiently transmit the light beam focused and delivered from the light source part (10), a coating for smoothing the transmission of the light beam may be added to at least one surface of the boundary window (21). The light beam generated in the light source part (10) passes through the boundary window (21) and may be configured to be irradiated onto the surface of the material in a form that transmits through the liquid collected in the liquid collection part (63).

The window holder (22) is a configuration for fixing the boundary window (21) to the front end of the light source supply unit (100a) and is formed in a ring-shaped cover structure with a hollow center. It can be configured to be fixed to the light source supply unit (100a) by binding the peripheral portion of the boundary window (21).

Here, the window holder (22) may be screw-coupled to the front end of the light source supply unit (100a), and the boundary window (21) may be fixed to the front end of the light source supply unit (100a) through the window holder (22). A sealing member (O) for preventing leakage may be disposed at each contact portion between the front end of the light source supply unit (100a) and the boundary window (21), and between the boundary window (21) and the window holder (22).

In addition, as a method of fixing the boundary window (21) to the front end of the light source supply unit (100a), adhesion, pressure assembly, or the like can be selectively applied as needed. The pressure assembly structure through the window holder (22) is preferable in that it can be convenient for maintenance if the coating formed on the boundary window (21) is damaged by continuous transmission of the focused laser light beam delivered from the light source part (10) or by the liquid.

Meanwhile, in the auxiliary module for machining equipment according to an embodiment of the present invention, the liquid supply unit (100b) is a configuration for supplying a liquid required to operate the auxiliary module. It may be configured to be coupled to the front end of the light source supply unit (100a) in a form including a body part (60) and a nozzle unit (70) for supplying a liquid such as water or cutting fluid.

The body part (60) is a configuration for transporting and collecting liquid supplied from the outside to be sprayed in the form of a liquid column and may comprise a supply port (61), a supply flow path (62), and a liquid collection part (63).

The supply port (61) forms a flow path for introducing liquid from the outside into the body part (60) of the liquid supply unit (100b). As shown in FIGS. 6 to 7, one or more supply ports (61) are formed to receive liquid from the outside, and the liquid introduced through the supply port (61) may be configured to move along the supply flow path (62).

In addition, a screen (not shown) in the form of a mesh may be further formed in the supply port (61). The screen is a device that can filter impurities and foam from the liquid introduced from the outside and simultaneously maintain a constant flow rate. Through this, the liquid collected in the liquid collection part (63), which will be described in detail later, can be collected in a state in which impurities, foam, and the like are filtered out.

Therefore, when the laser light beam supplied and transmitted from the light source supply unit (100a) passes through the liquid collected in the liquid collection part (63), the transmission is not hindered by impurities or foam, and smooth transmission can be achieved.

Meanwhile, the supply flow path (62) is for transporting the liquid supplied therein to the liquid collection part (63) in order to spray it through the nozzle unit (70). It can be freely configured to be located inside the liquid supply unit (100b), but preferably, as shown in FIG. 8A to 8B, it may be configured in a structure in which two members are coupled through the outer surface of the front end of the light source supply unit (100a) and the inner wall of the liquid supply unit (100b) to form a path extending toward the nozzle unit.

As such, since the supply flow path (62) is formed through the coupling of the light source supply unit (100a) and the liquid supply unit (100b), maintenance work can be performed by separating the light source supply unit (100a) and the liquid supply unit (100b), which has the effect of facilitating cleaning of the supply flow path (62).

The liquid collection part (63) is the final destination where the liquid introduced through the supply port (61) is transported via the supply flow path (62) and is the spray starting point for providing liquid to the nozzle unit (70). It is located at the center of the lower end of the liquid supply unit (100b), is tapered toward the nozzle unit (70), and can be configured such that a predetermined amount of liquid can accumulate therein. Its center is formed in a structure communicating with the nozzle unit (70) for spraying the liquid in the form of a liquid column.

The liquid collection part (63) is a point through which the laser light of the light source supply unit (100a) passes. The laser light beam supplied through the light source supply unit (100a) transmits through the liquid collected in the liquid collection part (63) and may be configured to be irradiated onto the workpiece through the nozzle unit (70), which will be described in detail later.

Additionally, a sealing member (O) for preventing leakage may be further provided at the coupling point of the light source supply unit (100a) and the liquid supply unit (100b) which are coupled to form the supply flow path (62). Furthermore, an outlet (65) for discharging a part of the liquid flow rate or partially reducing the liquid flow pressure may be further configured on one side of the supply flow path (62) or the body part (60) to prevent the spray shape of the liquid from being damaged when the liquid supplied through the supply port (61) is oversupplied even while being sprayed to the outside through the liquid collection part (63) and the nozzle unit (70).

Here, a pressure-reducing valve (65-1), which is controlled according to a signal from an internal pressure sensor or operated mechanically in conjunction with internal pressure, is further provided at the inlet of the outlet. By configuring the pressure-reducing valve to open and close according to the hydraulic pressure of the liquid flowing inside the supply flow path (62) or the body part (60), the discharge pressure or flow rate of the liquid collected through the liquid collection part (63) and discharged through the nozzle unit (70) can be maintained below a predetermined level.

Such a discharge structure for oversupplied liquid is less necessary when the liquid is continuously supplied at a constant flow rate through the supply port (61), but it can provide an effect of flexibly responding to instantaneous changes in liquid supply pressure due to pulsation, which commonly occurs in pumps that supply liquid.

In addition, in the structure forming the supply flow path (62), the supply port (61) is disposed at a higher position than the liquid collection part (63). Thus, small amounts of foam or bubbles remaining in the liquid float and deviate from the flow to move toward the supply port (61), so that the liquid collected in the liquid collection part (63) can have the effect of foam or bubbles being removed or minimized. Here, foam or bubbles accumulated inside the body part (60) can be easily removed from the inside of the body part (60) by being discharged through the nozzle unit by the high-speed flow of the liquid according to the cleaning or management cycle of the module, or by being discharged through a separately provided discharge valve, or by being discharged through the flow of liquid in an inverted state of the module.

Next, the nozzle unit (70) is located at the lower end of the liquid supply unit (100b) to spray the liquid and the laser light beam and may comprise a spray port (71) and a spray stage (72).

The spray port (71) is a configuration for spraying the laser light beam supplied from the light source supply unit (100a) and the liquid supplied from the liquid supply unit (100b) onto the workpiece, and can be configured so that the laser light beam and the liquid can be sprayed together.

The liquid sprayed through the spray port (71) is configured to be sprayed in the shape of a liquid column through the hydraulic pressure of the supplied liquid as described above, and does not have a separate internal or external configuration for spraying the liquid at high pressure. The laser light beam irradiated through the spray port (71) may be configured to transmit through the liquid naturally sprayed in the form of a liquid column by the supplied pressure, and to be irradiated without being scattered to the outside along the flow of the liquid.

That is, the liquid sprayed through the spray port (71) may be composed of water or cutting fluid, and the spraying of such liquid may be configured to be sprayed using natural flow pressure to provide a predetermined spray flow rate rather than high-pressure spraying.

Therefore, it is preferable that the liquid sprayed from the spray port (71) reaches the surface of the workpiece by being sprayed in the form of a liquid column without being spread or distorted laterally. The laser light beam may be irradiated in a form in which light energy is supplied to the surface of the workpiece by simply transmitting through the liquid inside the liquid sprayed in the form of such a liquid column or by transmitting and being irradiated in a form in which light is focused while causing total internal reflection. At this time, it is more preferable that the sprayed liquid is sprayed in a laminar flow state.

The liquid such as water or cutting fluid sprayed in this way not only forms a light-guiding medium for guiding the light beam to the surface of the material but also can block or reduce the chemical reaction with gas in the air when the surface of the material is locally melted due to the irradiation of the laser light beam. This further provides convenience or utility in that the output of a light beam such as a laser can be further increased and used as needed.

In addition, a laser irradiated onto the machining surface of a material may be reflected or scattered from the surface depending on the characteristics of the material. As the laser is irradiated along with the spray of liquid from the spray port (71), the light beam can be configured to be focused like a lens on the surface of the workpiece due to the sprayed liquid. This has the effect of improving the focusing efficiency of the laser light beam even for workpieces formed of materials such as glass or diamond with high permeability or high reflectivity.

In addition, the liquid sprayed through the spray port (71) is configured to reach a position ahead of the machining path or the machining position of the tool in machining the material using the tool, thereby providing an effect that the surface strength of the workpiece can be softened by the laser irradiation that reaches together while transmitting through the liquid.

Due to this, even if the strength or brittleness of the workpiece is high, a softening effect on the surface can be performed during machining through the tool, so that machining precision can be improved and damage due to tool wear can be reduced.

In addition, compared to direct laser irradiation, irradiation while the liquid is sprayed can suppress damage to the surface of the material through the laser, and can also prevent overheating of the tool as the liquid is sprayed onto the tool that is frictioned during the machining process of the material.

Furthermore, when only the laser is irradiated on the surface, the formed temperature distribution is spread widely. In such a widely spread temperature distribution, the temperature accumulates due to residual heat, making it difficult for the user to precisely control the temperature, position, or area of the material surface. The auxiliary module for machining equipment according to an embodiment of the present invention is a method of simultaneously applying a cold element and a hot element to the surface of a material, so that a precise temperature distribution can be formed, and thereby the precision for machining can be remarkably improved.

Meanwhile, the spray stage (72) may be provided in a form protruding from the lower part of the liquid supply unit (100b) and corresponds to a structure for guiding the sprayed liquid to accurately spray onto a target point of the workpiece according to the type and properties of the sprayed liquid.

That is, it is necessary to form a structure in which the liquid sprayed from the spray port (71) is sprayed in the form of a concentrated and continuous water column flow without being spread or distorted laterally when sprayed by the supply pressure. For this purpose, it is preferable to configure the spray stage (72) in which the spray port (71) is formed to ensure a predetermined length or more.

Therefore, the spray stage (72) may be provided in a form protruding from the lower end of the liquid supply unit (100b) by a predetermined length to serve as a configuration for guiding the flow of the liquid sprayed from the liquid supply unit (100b).

In addition, summarizing the machining method according to an embodiment of the present invention, it is a machining method for performing machining on a surface of a material by a machining tool, comprising: preparing an auxiliary module for machining equipment, capable of spraying a liquid including water or cutting fluid, in the vicinity of the machining tool; fixing the material to be machined to a bed or a spindle; and machining the material by bringing the machining tool close to the surface of the material, wherein the step of machining the material may be configured to spray the liquid from the auxiliary module for machining equipment in the form of a liquid column to a machining position of the machining tool or ahead of a machining path, while the light beam of the auxiliary module for machining equipment is configured to transmit through the liquid and be irradiated together. The light beam may be irradiated in a form in which light energy is supplied to the surface of the workpiece by simply transmitting through the liquid inside the liquid sprayed in the form of such a liquid column or by transmitting and being irradiated in a form in which it is focused while causing total internal reflection.

Meanwhile, considering the environment in which the auxiliary module for machining equipment or the machining method of the present invention is used, the auxiliary module of the present invention may be used in a state in which the device is standing vertically in spraying liquid and irradiating laser toward a workpiece, while being fixed at one end after being prepared near the machining equipment. However, it may also be used in a state in which it is tilted diagonally or laid horizontally. In this case, a situation may occur in which it is difficult to spray liquid to a target point because the pressure of the liquid sprayed from the spray port (71) is insufficient.

To solve this, if the pressure for spraying the liquid is increased, the properties of the flow may change, making it difficult to form a water column shape or changing the guiding function for the light beam, which is not desirable. Moving the entire module close to the workpiece is also not desirable due to concerns about interference or collision between the body part (60) of the module and surrounding configurations.

In such a case, to ensure spray delivery performance without changing the flow properties of the liquid sprayed from the spray port (71), the spray delivery performance of the liquid sprayed from the spray port (71) can be improved by extending the length of the spray stage (72).

Here, it is preferable to select and configure the diameter of the spray port (71) and the length of the spray stage (72) in consideration of the type and property of the liquid sprayed from the spray port (71). The diameter of the spray port (71) and the length of the spray stage (72) need to be configured differently according to the environment in which the auxiliary module for machining equipment of the present invention is used. As shown in FIG. 10A to 10C, as another embodiment of the nozzle unit (70), a replacement stage (71a) structure is formed so that the nozzle unit (70) can be replaced and coupled to the lower end of the body part (60) of the liquid supply unit (100b), whereby the nozzle unit (70) is configured in a form that is detachably fastened to the lower end of the body part (60) through the replacement stage (71a). Through this, a structure in which the diameter of the spray port (71) can be easily replaced can be formed.

In addition, the nozzle unit (70) may further comprise a coupling stage (72a) as a fastening structure for changing the total length of the spray stage (72). If necessary, the spray stage (72) can be replaced and fastened to the coupling stage (72a), or can be fastened cumulatively to change the total length of the spray stage (72).

Therefore, in the auxiliary module for machining equipment according to an embodiment of the present invention, the nozzle unit (70) can have an effect that the diameter of the spray port (71) or the length of the spray stage (72) can be freely adjusted as needed by the replacement stage (71a) or the coupling stage (72a).

In addition, depending on the properties of the liquid supplied from the liquid supply unit (100b) or the diameter of the spray port (71), the distance of the sprayed liquid may vary. At this time, besides increasing the spray delivery performance through the change in the length of the spray stage (72), it may be necessary to reset the focus of the light beam supplied from the light source supply unit (100a).

Therefore, describing a modified embodiment of the light source supply unit (100a), the structure of the light source part (10) and the boundary part (20) constituting the light source supply unit (100a) may be configured in a separable structure in which a light source housing (14) and a boundary housing (23) are provided, respectively, as shown in FIGS. 11 to 12.

The light source housing (14) may be provided as a body for mounting other components of the light source part (10) at the rear end, and the boundary housing (23) may be configured in a form in which other components of the boundary part (20) are mounted at the front end, and the light source housing (14) may be configured to be coupled to the rear end of the boundary housing (23).

Therefore, in using the auxiliary module for machining equipment of the present invention, when it is necessary to adjust the focus of the light beam or change the laser, only the light source part (10) can be separated from the light source supply unit (100a) instead of separating the light source supply unit (100a) and the liquid supply unit (100b), so that replacement and adjustment of the supplied light beam can be performed simply.

Meanwhile, in the work of adjusting the focus of the light beam generated and supplied from the light source part (10), it may be common to replace or adjust the position of the light source lens (12). However, when it is only necessary to adjust the distance at which the focus is specified, the distance between the light source part (10) and the nozzle unit (70) can be adjusted by providing a structure for adjusting the distance between the light source part (10) and the boundary part (20), rather than replacing or changing the position of the light source lens (12). Through this adjustment structure, the focus of the light beam supplied from the light source part (10) can be easily adjusted so as to be irradiated through the spray port (71).

Accordingly, the gap (30) between the two components can be easily adjusted through the coupling structure between the light source housing (14) and the boundary housing (23), and thus the position of the light source housing (14) relative to the boundary housing (23) can be adjusted. It is preferable to provide a lever (not shown) for a handle for such gap adjustment on the outer surface of the light source mount (11) or the light source housing (14), and the focus can be more easily adjusted in real-time through these adjustment structures even when the device is installed to proceed with machining work.

As described above, the light source supply unit (100a) and the liquid supply unit (100b) of the present invention can easily adjust the focus of the light beam to be irradiated according to the type and properties of the supplied liquid and the working environment, and can conveniently adjust the diameter and length of the spray port (71) where the liquid is sprayed, thereby providing an effect of easily implementing the function of softening the surface of the workpiece in proceeding with the machining work.

Meanwhile, the auxiliary module for machining equipment or the machining method according to an embodiment of the present invention may further comprise a temperature control unit (not shown) for the liquid including water or cutting fluid to adjust the temperature of the liquid. A light beam such as a laser that transmits light through a liquid can raise the temperature of the liquid including water or cutting fluid, and even a small temperature change significantly affects the machining quality in ultra-precision or precision machining, so it is preferable to provide the temperature control unit.

Here, the temperature control unit may be formed as an internal configuration or structure, such as a method of heat exchange by flowing a heat medium inside a heat exchange member provided to be exposed on the flow path of the liquid in the body part (60) of the auxiliary module, a method of heat exchange by internally flowing a heat medium in a heat medium flow path formed in a buried structure inside the wall material of the body part (60) or the nozzle unit (70), or a method of heat exchange by heat transfer through the inner wall of the nozzle unit by flowing a heat medium inside a heat exchange member provided to surround the nozzle unit (70) from the outside. Alternatively, it may be formed as an external configuration or structure, such as a method of controlling temperature by providing a heat exchange member in a stage prior to introducing the liquid into the supply port (61) of the body part (60), or a method of controlling temperature by providing a heat exchange member on a path for recovering and circulating the liquid after providing it to the workpiece through the nozzle unit (70).

In addition, the auxiliary module for machining equipment or the machining method of the present invention is not limited to the use of a cutting type exemplarily shown through FIG. 1 and the like in the previous description. That is, for example, as shown in FIG. 13, in drilling, drilling can be performed through a method in which the machining position—such as the surface of the workpiece (M) fixed to the bed or spindle (S) or the bottom of the hole being processed—is softened through liquid spraying and light beam irradiation just before the machining approach of the tool (T), and then the drilling tool (T) is approached for machining. During the drilling operation of the drilling tool, it is preferable to stop the operation of at least the light beam such as a laser.

In addition, the liquid sprayed in the form of a liquid column used in the auxiliary module for machining equipment or the machining method of the present invention is not limited to linear spraying. That is, the liquid spray in the form of a liquid column may be selected as necessary to be formed in a curved shape by self-weight, and accordingly, the guiding path of the light beam is also formed to be curved. A user can advantageously use such a geometric structure according to the needs of the corresponding machining process.

Furthermore, in the auxiliary module for machining equipment or the machining method of the present invention, the cross-sectional shape of the light beam is not limited to a circular shape, and the number is not limited to a single one. For example, considering the shape of the machining tool or the machining structure, a plurality of liquid columns may be provided close to the surface of the material as needed, and a plurality of light beams transmitting through each liquid column may be irradiated to broadly soften the surface of the material in the form of a strip or band to perform the corresponding machining process. As another example, it can also be implemented in a modified structure, such as a method of forming the cross-section of the liquid column into a strip or band shape by modifying the shape of the spray flow path of the nozzle unit, and irradiating a plurality of light beams along the strip or band-shaped liquid column.

Besides, the description of the present invention described above is for illustration, and those of ordinary skill in the art to which the present invention pertains will be able to understand that it can be easily transformed into other specific forms without changing the technical idea or essential features of the present invention. Therefore, it should be understood that the embodiments described above are illustrative in all respects and not restrictive. For example, each component described as a single type may be implemented in a distributed or divided manner, and similarly, components described as distributed or divided may also be implemented in a combined form within the range understood by those skilled in the art. In addition, the steps of the method may be implemented in a form of being performed multiple times alone or in combination with at least one other step multiple times.

The scope of the present invention is indicated by the claims to be described later, and all changes or modified forms derived from the meaning and scope of the claims and their equivalent concepts should be interpreted as being included in the scope of the present invention.

### EXPLANATION OF REFERENCE NUMERALS

100: AUXILIARY MODULE FOR MACHINING EQUIPMENT (APPARATUS)

100a: LIGHT SOURCE SUPPLY UNIT

10: LIGHT SOURCE PART

11: LIGHT SOURCE MOUNT

11a: MOUNTING/FIXING HOLE

12: LIGHT SOURCE LENS

13: SPACER

13a: OUTER DIAMETER SPACER

13b: INNER DIAMETER SPACER

13c: THREAD

13d: FIXING RING

14: LIGHT SOURCE HOUSING

20: BOUNDARY PART

21: BOUNDARY WINDOW

22: WINDOW HOLDER

23: BOUNDARY HOUSING

30: GAP

100b: LIQUID SUPPLY UNIT

60: BODY PART

61: SUPPLY PORT

62: SUPPLY FLOW PATH

63: LIQUID COLLECTION PART

70: NOZZLE UNIT

71: SPRAY PORT

71a: REPLACEMENT STAGE

72: SPRAY STAGE

72a: COUPLING STAGE

L: LIGHT BEAM GENERATING DEVICE

O: SEALING MEMBER

T: MACHINING TOOL

M: WORKPIECE (MACHINING MATERIAL)

S: SPINDLE OR BED

1. An auxiliary module for machining equipment for assisting machining of a surface of a workpiece by a machining tool, the auxiliary module comprising:
a light source supply unit (100a) configured to supply a light beam for irradiation onto the surface of the workpiece; and
a liquid supply unit (100b) configured to supply a liquid including water or cutting fluid;
wherein the liquid supply unit (100b) includes a nozzle unit (70) configured to spray the liquid together with the light beam supplied from the light source supply unit (100a),
and the light beam and the liquid are configured to reach a machining position of the machining tool or a position ahead of a machining path.

2. The auxiliary module for machining equipment according to claim 1,
wherein the light source supply unit (100a) comprises: a light beam generating device (L) for generating the light beam; and one or more light source lenses (12) provided to focus or converge the light beam generated by the light beam generating device (L).

3. The auxiliary module for machining equipment according to claim 2,
wherein the light beam irradiated through the light source supply unit (100a) is a laser light beam, and is irradiated at an output provided or adjusted to induce a softening effect on the surface of the workpiece to be machined.

4. The auxiliary module for machining equipment according to claim 2,
wherein the nozzle unit (70) is configured to spray the liquid in the form of a liquid column so as to reach the surface of the workpiece.

5. The auxiliary module for machining equipment according to any one of claim 1,
wherein the light source supply unit (100a) comprises: a light source part (10) provided to supply the light beam; and a boundary part (20) forming an interface in contact with the liquid of the liquid supply unit (100b) in front of the light source part (10), wherein the light source part (10) is configured in a structure that is repositionable relative to the nozzle unit (70).

6. The auxiliary module for machining equipment according to claim 1,
wherein the liquid supply unit (100b) comprises a body part (60) for receiving, transporting, and collecting a liquid from the outside to be sprayed in the form of a liquid column, and
wherein the body part (60) is provided with a liquid collection part (63) at a portion communicating with the nozzle unit (70) to accumulate a predetermined amount of the liquid and provide the liquid to the nozzle unit (70).

7. The auxiliary module for machining equipment according to claim 6,
wherein in the body part (60), a supply port (61), which is a flow path for introducing the liquid from the outside, is formed at a position higher than the liquid collection part (63).

8. The auxiliary module for machining equipment according to claim 1,
wherein the liquid supply unit (100b) comprises a body part (60) for receiving, transporting, and collecting a liquid from the outside to be sprayed in the form of a liquid column, and
wherein the body part (60) further comprises: an outlet (65) for discharging a part of a flow rate of the liquid or partially reducing a flow pressure of the liquid from the body part (60); and a pressure-reducing valve (60-1.) for opening and closing the outlet by being controlled according to a signal from a pressure sensor for sensing an internal pressure of the body part or being operated mechanically in conjunction with the internal pressure.

9. The auxiliary module for machining equipment according to claim 1,
further comprising a temperature control unit for restricting a temperature of the liquid from being increased by a light beam transmitting through the liquid.

10. The auxiliary module for machining equipment according to claim 1,
wherein the nozzle unit (70) is formed separately and is detachably assembled to a front end of the liquid supply unit (100b).

11. A machining method for performing machining on a surface of a workpiece by a machining tool, the method comprising:
preparing an auxiliary module for machining equipment in the vicinity of the machining tool, the auxiliary module being capable of spraying a liquid including water or cutting fluid;
fixing the workpiece to be machined to a bed or a spindle; and
machining the workpiece by bringing the machining tool close to the surface of the workpiece;
wherein the step of machining the workpiece comprises spraying the liquid from the auxiliary module for machining equipment to a machining position of the machining tool or a position ahead of a machining path, while the light beam of the auxiliary module for machining equipment is configured to transmit through the liquid and be irradiated together.
